(19) United States
(12) Patent Application Publication
(10) Pub. No.: US 2021/0298279 A1
(43) Pub. Date: Sep. 30, 2021

(54) STICKBAIT FISHING LURE AND PROCESS OF FORMING AN IMPROVED STICKBAIT FISHING LURE

(71) Applicant: Scott Graham, Southlake, TX (US)

(72) Inventor: Scott Graham, Southlake, TX (US)

(21) Appl. No.: 17/215,382

(22) Filed: Mar. 29, 2021

Related U.S. Application Data
(60) Provisional application No. 63/166,482, filed on Mar. 26, 2021.
(60) Provisional application No. 63/002,061, filed on Mar. 30, 2020.

(51) Int. Cl. A01K 85/00; B29C 45/00; B29C 45/14

(52) U.S. Cl. CPC A01K 85/00; B29K 2707/00; B29C 45/14065; B29C 45/0001

(57) ABSTRACT

A stickbait fishing lure includes an outer covering and an internal structure molded within the outer covering. The internal structure is of a material that is configured to be punctured by a fishing hook. With this configuration, a fishing hook can be passed through the outer covering and puncture the material of the internal structure. The internal structure helps secure the fishing hook within the fishing lure by providing an internal reinforcement that inhibits the inserted hook from ripping away from the fishing lure or otherwise tearing the outer covering.

### CROSS REFERENCE TO RELATED APPLICATIONS

The present application is a non-provisional application that claims priority to U.S. Provisional Application No. 63/002,061 filed on Mar. 30, 2020, and claims priority to U.S. Provisional Application No. 63/166,482 filed on Mar. 26, 2021. The disclosures of the prior applications are hereby incorporated by reference herein in their entireties.

### FIELD OF THE INVENTION

The present application relates, generally, to a stickbait fishing lure, and to processes of forming a stickbait fishing lure. More specifically, the application relates to an improved stickbait fishing lure having a configuration that helps secure a fishing hook within the stickbait fishing lure by providing an internal reinforcement that inhibits the inserted hook from ripping away from the fishing lure or otherwise tearing the outer covering. The application also relates to processes of forming such an improved stickbait fishing lure.

### BACKGROUND

Several types of fishing lures are known. Some fishing lures are worm-shaped. One type of worm-shaped fishing lure is a “stickbait” type fishing lure. A stickbait type fishing lure is rigged by attaching a fishing hook to the lure around a central portion of the lure. The stickbait type fishing lure is different from other known worm-shaped fishing lures, such as a “ned rig” fishing lure that is rigged by attaching a fishing hook to one of the ends of the lure. A “Texas rig” fishing lure also is rigged by attaching a fishing hook to an end of the lure, although the fishing hook does not protrude out of the lure as much as with the ned rig fishing lure. Those familiar with these types of fishing lures thus understand the difference between a stickbait type fishing lure and other types of fishing lures, including worm-shaped fishing lures. A common worm-shaped fishing lure is formed of plastisol material, which provides the lure with a worm-like texture and a worm-like movement in the water. Rigging a stickbait type lure of plastisol generally involves puncturing the lure with a fishing hook. The rigged lure is then cast into the water. A problem associated with rigging the plastisol stickbait type lure is the risk that the inserted fishing hook may unintentionally rip away from the lure or otherwise tear the plastisol material and destroy the lure.

A need exists for a stickbait type fishing lure having a construction that helps prevent an inserted fishing hook from ripping away from the lure or otherwise tearing the plastisol outer covering, while still maintaining the appearance and worm-like characteristics of the lure.

The features of the stickbait fishing lure discussed herein meet these needs.

### SUMMARY

The inventor of the present application has developed an improved stickbait fishing lure, and processes of forming an improved stickbait fishing lure.

In one embodiment, a stickbait fishing lure comprises an outer covering; and an internal structure molded within the outer covering, wherein the internal structure is of a material that is configured to be punctured by a fishing hook.

In this configuration, a fishing hook is able to be inserted through the outer covering and puncture the internal structure. The internal structure helps secure the fishing hook within the stickbait fishing lure by providing an internal reinforcement that inhibits the inserted hook from ripping away from the lure or otherwise tearing the outer covering.

In an embodiment, the material of the internal structure is silicon.

In an embodiment, the outer covering is formed of plastisol material.

In an embodiment, the internal structure includes a plurality of prominent portions along a length of the internal structure.

In an embodiment, one or more of the plurality of prominent portions comprises a peanut shape.

In an embodiment, at least one of the plurality of prominent portions comprises an arm extending therefrom.

In an embodiment, the arm comprises a protrusion at a distal end thereof.

In an embodiment, the internal structure further comprises a disc-shaped element adjacent one of the plurality of prominent portions.

In a further embodiment, a stickbait fishing lure comprises an outer covering; and an internal structure molded within the outer covering, wherein the internal structure includes a plurality of prominent portions along a length of the internal structure.

In this configuration, a fishing hook is able to be inserted through the outer covering and puncture one of the prominent portions of the internal structure. The hook may also be passed through the prominent portion and out of the opposite side of the outer covering. The prominent portion helps secure the fishing hook within the lure by providing an internal reinforcement that inhibits the inserted hook from ripping away from the lure or otherwise tearing the outer covering.

In the further embodiment, the internal structure may be formed of silicon material.

In the further embodiment, the outer covering may be formed of plastisol material.

In the further embodiment, one or more of the plurality of prominent portions comprises a peanut shape.

In the further embodiment, the internal structure further comprises a disc-shaped element adjacent one of the plurality of prominent portions.

In the further embodiment, at least one of the plurality of prominent portions comprises an arm extending therefrom, and the arm comprises a protrusion at a distal end thereof.

Another embodiment involves a process of forming a fishing lure, comprising positioning an internal structure into a cavity of a mold so that an arm of the internal structure engages a respective placeholder on the mold, and so that a protrusion of the arm is located outside of the cavity, so as to be exposed externally of the mold, wherein engagement of the arm and the respective placeholder suspends the internal structure within the cavity; injecting a material into the cavity to envelope the internal structure and form an outer covering having the internal structure molded therein; curing the material; removing from the mold the outer covering having the internal structure molded therein; and removing the protrusion from the internal structure.

In an embodiment of the process, the internal structure is formed of a material that is configured to be punctured with a fishing hook.

In an embodiment of the process, the internal structure is formed of silicon material.

In an embodiment of the process, the material injected into the cavity of the mold is plastisol.

In an embodiment of the process, the internal structure includes a plurality of prominent portions located along a length of the internal structure, and the arm extends from one of the plurality of prominent portions.

In an embodiment of the process, the internal structure further comprises a disc-shaped element between adjacent prominent portions.

### BRIEF DESCRIPTION OF THE DRAWINGS

FIG. 1A illustrates a perspective view of an outer covering for a fishing lure, according to an embodiment.

FIG. 1B is a one-dimensional side view of the outer covering shown in FIG. 1A, according to an embodiment.

FIG. 1C is a cross-sectional view of the outer covering along line A-A in FIG. 1B, according to an embodiment.

FIG. 2A illustrates a perspective view of an internal structure for a fishing lure, according to an embodiment.

FIG. 2B is a one-dimensional side view of the internal structure shown in FIG. 2A, according to an embodiment.

FIG. 2C is an end view of the internal structure shown in FIGS. 2A and 2B, according to an embodiment.

FIG. 2D illustrates a perspective view of a second embodiment of an internal structure for a fishing lure.

FIG. 2E is a one-dimensional side view of the second embodiment shown in FIG. 2D.

FIG. 2F is an end view of the internal structure shown in FIGS. 2D and DE, according to the second embodiment.

FIG. 3 is a perspective view of a fishing lure including the internal structure molded within the outer covering, according to an embodiment.

FIG. 4 is a flow chart showing steps in a process of forming a fishing lure, according to an embodiment.

FIG. 5 is a flow chart showing steps in a process of forming a fishing lure according to the second embodiment.

FIG. 6 is a perspective view of a fishing lure including the internal structure molded within the outer covering according to the second embodiment.

### DESCRIPTION

Before describing selected embodiments of the present disclosure in detail, it is to be understood that the present invention is not limited to the particular embodiments described herein. The disclosure and description herein is illustrative and explanatory of one or more presently preferred embodiments and variations thereof, and it will be appreciated by those skilled in the art that various changes in the design, organization, means of operation, structures and location, methodology, and use of mechanical equivalents may be made without departing from the spirit of the invention.

As well, it should be understood that the drawings are intended to illustrate and plainly disclose presently preferred embodiments to one of skill in the art, but are not intended to be manufacturing level drawings or renditions of final products and may include simplified conceptual views to facilitate understanding or explanation. As well, the relative size and arrangement of the components may differ from that shown and still operate within the spirit of the invention.

Moreover, it will be understood that various directions such as “upper”, “lower”, “bottom”, “top”, “left”, “right”, and so forth are made only with respect to explanation in conjunction with the drawings, and that components may be oriented differently, for instance, during transportation and manufacturing as well as in operation. Because many varying and different embodiments may be made within the scope of the concept(s) herein taught, and because many modifications may be made in the embodiments described herein, it is to be understood that the details herein are to be interpreted as illustrative and non-limiting.

Before explaining selected embodiments of the present invention in detail, it is to be understood that the present invention is not limited to the particular embodiments described herein and that the present invention can be practiced or carried out in various ways.

An embodiment of a stickbait fishing lure 10 will be described by first discussing its component parts. It is noted at the outset that the stickbait fishing lure 10 discussed herein is different than other known fishing lures because, as discussed above, a stickbait fishing lure is worm-shaped, and is rigged by attaching a fishing hook to the lure around a central portion of the lure. The stickbait fishing lure 10 is thus different from other types of fishing lures that are not worm-shaped, and is also different from other worm-shaped lures such as a “ned rig” fishing lure and a “Texas rig” fishing lure, which are rigged by attaching a fishing hook to one of the ends of the lure. Those familiar with these types of fishing lures thus understand that there is a difference between a stickbait fishing lure and other types of fishing lures, including worm-shaped fishing lures.

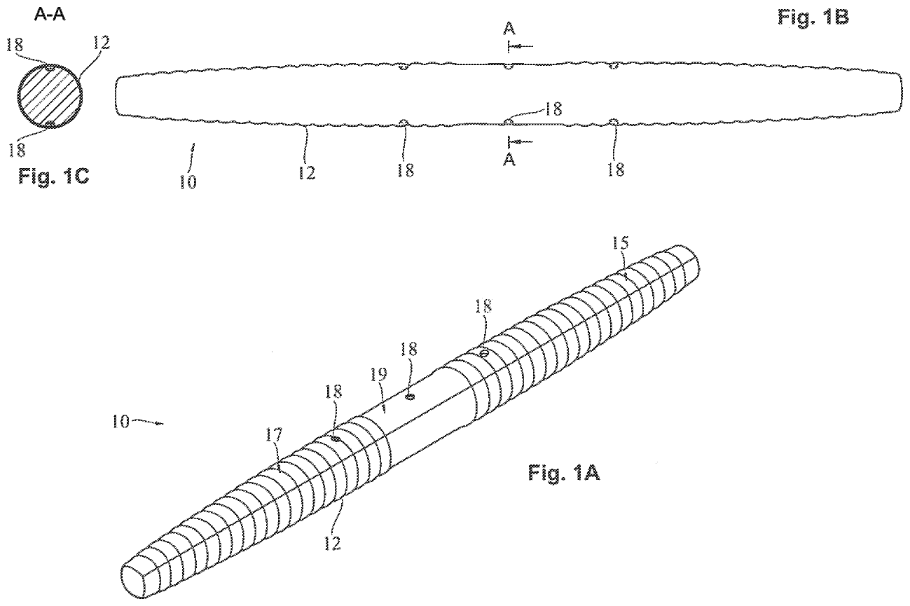

FIG. 1A shows an embodiment of an outer covering 12 of the stickbait fishing lure 10. The outer covering 12 may be formed of a plastisol material that is molded into the shape of a worm so that the stickbait fishing lure 10 is worm-shaped. The material of the outer covering 12 is not limited to plastisol however. In other embodiments, the material of the outer covering 12 may be any malleable plastic material. Whatever material is selected to form the outer covering 12, the material should be of the type that provides the outer covering 12 with flexibility, resiliency, and a texture that resembles the characteristics of a worm, such as an earthworm or a nightcrawler, that is typically used as live bait for fishing. For instance, the outer covering 12 illustrated in FIG. 1A may include a clitellum portion 19 between a “head” portion 17 and a “tail” portion 15. The “head” portion 17 and the “tail” portion 15 may include ridges so that those portions appear similar to the segmented body of a worm. Further, the material of the outer covering 12 should preferably be of the type that is able to be injected into a mold and cured after a molding process of the material is completed. The overall length of the outer covering 12 is not particularly limiting, and in some embodiments the length of the outer covering 12 may be anywhere from two to eight inches. The outer diameter of the outer covering 12 also is not particularly limiting, and in some embodiments the diameter may be anywhere from a quarter inch to one inch. With respect to a particular combination of the length and diameter dimensions of the outer covering 12, the combination thereof should make the outer covering 12 resemble the shape of a worm, such as an earthworm or a nightcrawler.

In addition, the clitellum portion 19 may include text or other design, such as a company logo. Other portions of the outer covering 12 may also include text or other design. The color of the outer covering 12 also is not particularly limited, and the outer covering 12 may include designs, patterns, and graphics to go along with any color of the outer covering 12.

FIG. 1A also shows that the outer covering 12 may include holes 18 or marks spaced from each other in a direction along a length of the outer covering 12. In the illustrated embodiment, each side of the outer covering 12 includes three holes 18 or marks located in a more central portion of the outer covering 12. For instance, one hole 18 may be located in the clitellum portion 19, another hole 18 may be located in the “head” portion 17 in relatively close proximity to the clitellum portion 19, and a third hole 18 may be located in the “tail” portion 15 in relatively close proximity to the clitellum portion 19, as shown in FIG. 1A. In another embodiment, the outer covering 12 may include no holes 18. In other embodiments, the outer covering 12 may include one or two holes, and in further embodiments the outer covering 12 may include four or more holes 18. While a fishing hook may be inserted into various parts of the outer covering 12 by puncturing the surface of the outer covering 12, the holes 18 or marks may serve as indicators showing suitable locations for inserting the fishing hook to provide a more secure attachment of the fishing hook, as discussed in further detail below.

One reason for providing the holes 18 or marks in the outer covering 12 may be to provide a user of the stickbait fishing lure 10 with different options for where to attach the fishing hook on the outer covering 12. Attaching the fishing hook at different locations on the outer covering 12 may affect how the stickbait fishing lure 10 will behave in the water. That is, casting the rigged stickbait fishing lure 10 into the water with a fishing hook attached at the hole 18 or mark in the clitellum portion 19 will provide the stickbait fishing lure 10 with a different action (e.g., movement) of the stickbait fishing lure 10 in water than when the fishing hook is attached at a hole 18 or mark in either the head” portion 17 or the “tail” portion 15. This is notable because certain fish may act differently depending on the season of the calendar year. If the rigged stickbait fishing lure 10 is used in a season in which the fish are not very active, more movement of the rigged stickbait fishing lure 10 in the water may be required to attract the fish's attention. When the rigged stickbait fishing lure 10 is used in a season in which the fish are active, less movement of the rigged stickbait fishing lure 10 in the water may be required to attract the fish's attention. As an alternative to the holes 18 as indicators for where to attach the fishing hook to the stickbait fishing lure 10, the outer covering 12 may instead include markers, such as dots, printed on or otherwise added to the outer surface of the outer covering 12.

FIG. 1B is a one-dimensional side view of the outer covering 12, and FIG. 1C is a cross-sectional view of the outer covering 12 along line A-A in FIG. 1B.

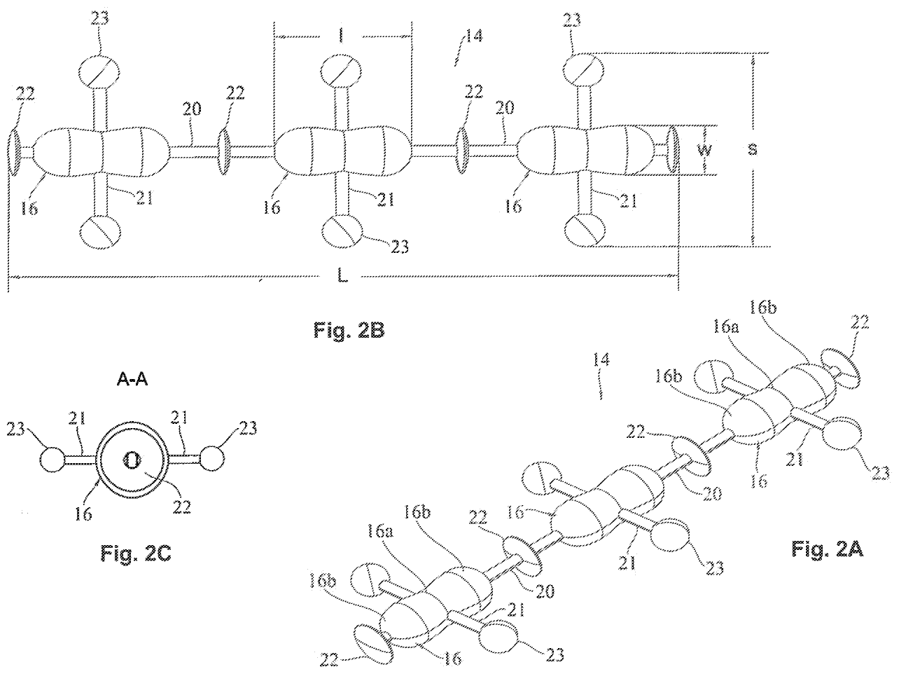

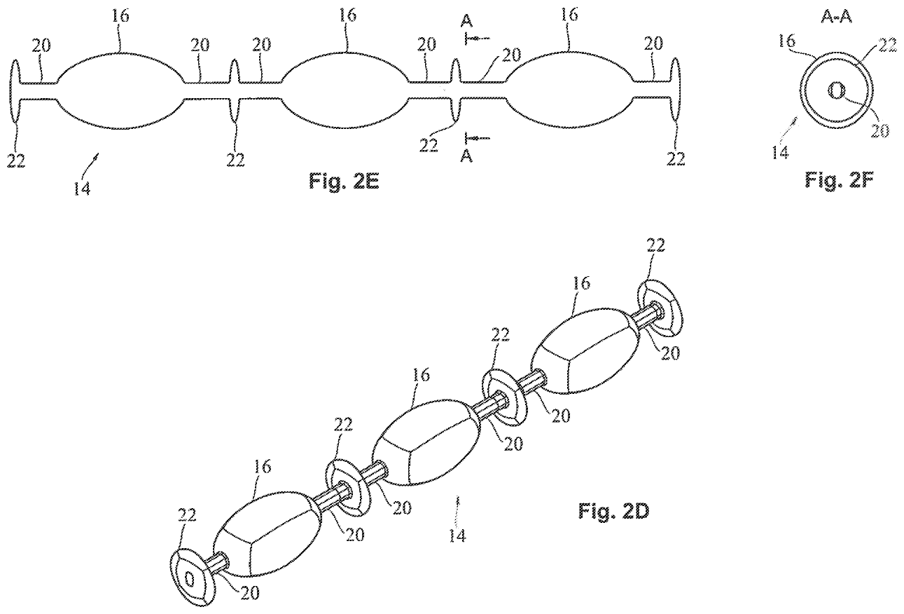

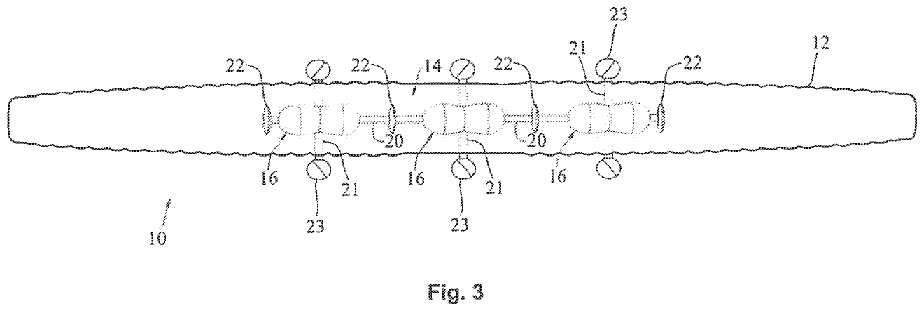

FIG. 2A shows an embodiment of an internal structure 14 of the stickbait fishing lure 10. The internal structure 14 is configured to be molded within the outer covering 12, such as in a process described below, to form the stickbait fishing lure 10. That is, the stickbait fishing lure 10 is formed of the internal structure 14 molded within the outer covering 12. The internal structure 14 may be formed of a silicon material, so as to function or act as, among other things, a flexible spine of the stickbait fishing lure 10. The material of the internal structure 14 is not limited to silicon however. In other embodiments, the material of the internal structure 14 may be any malleable plastic material. Whatever material is selected to form the internal structure 14, the material should be of the type that provides the internal structure 14 with flexibility and resiliency, yet being not as flexible and resilient as the material of the outer covering 12 so that the internal structure 14 provides some aspect of rigidity (as a flexible and resilient spine) to the stickbait fishing lure 10.

In addition, the material of the internal structure 14 should have the ability to be punctured and re-punctured with a fishing hook. “Puncture”, “puncturing”, “re-punctured” and other variations of the word “puncture” as used herein is meant to indicate that the actual structure of the material of the internal structure 14 is being separated, disrupted and/or disturbed by the object (e.g., fishing hook) doing the puncturing. This is in contrast to, for example, a mesh material, fibrous material, or a hoop-shaped material, in which the fishing hook is simply passed through an opening between strands of the mesh; between strands of the fibrous material; or passed through the center of the hoop-shaped material. In those cases, the fishing hook does not cut, tear, or otherwise adversely affect the structure of the material of the mesh, the material of the fibers, or the material forming the hoop-shape. The material of the internal structure 14 should have the ability to be re-punctured with a fishing hook several times without losing its structural integrity, so that the stickbait fishing lure 10 can be repeatedly used over the course of its life. The internal structure 14 may provide a better grip on a fishing hook than the material of the outer covering 12. The internal structure 14 is thus intended to be punctured by a fishing hook to help secure the fishing hook within the stickbait fishing lure 10 by providing an internal reinforcement that inhibits the inserted hook from ripping away from the outer covering 12 or otherwise tearing the outer covering 12 and damaging the stickbait fishing lure 10.

The internal structure 14 may include a plurality of prominent portions 16 along a length of the internal structure 14 as shown in FIG. 2A. The prominent portions 16 may protrude radially outward from a main shaft 20 of the internal structure 14, so that the outer diameter of each prominent portion 16 is greater than the outer diameter of the main shaft 20. In the illustrated embodiment shown in FIGS. 2A and 2B, the internal structure 14 has a total of three prominent portions 16. However, the internal structure 14 may have more or less than three prominent portions 16. The prominent portions 16 provide a greater target area for an inserted fishing hook to puncture the internal structure 14, while the smaller diameter main shaft 20 allows for the internal structure 14 to have flexibility and movement comparable to a worm in water. The location of each prominent portion 16 within the outer covering 12 (in order to help a person know where to insert the fishing hook in the stickbait fishing lure 10 so that the fishing hook punctures a prominent portion 16) may be determined in several ways. To begin with, because the material of the outer covering 12 is softer than the material of the internal structure 14, the location of the prominent portions 16 may be apparent simply by pressing against the outer covering 12 (e.g., with the person's fingers) to feel where the prominent portions 16 are located. In another embodiment, the outer covering 12 may be formed of a transparent material, so that the prominent portions 16 of the internal structure 14 are visible to a person through the outer covering 12. As discussed above, the holes 18 or marks may be provided at locations along the outer covering 12 that correspond to the locations of the prominent portions 16 of the internal structure 14 within the outer covering 12, to provide a visual indicator of the location of the prominent portions 16 within the outer covering 12. In a further embodiment, the outer covering 12 may include markers (not shown), such as dots, printed on or otherwise added to the outer surface of the outer covering 12, at locations corresponding to the locations of the prominent portions 16 within the outer covering 12, as discussed above. In this case, the user would be able to insert the fishing hook into the outer covering 12 at one of the markers so that the fishing hook then punctures one of the prominent portions 16 behind (corresponding to the location of) the marker.

FIGS. 2A and 2B show an embodiment in which the prominent portions 16 have a peanut shape. For instance, the central portion 16a of the prominent portion 16 may have a smaller circumferential dimension than the opposing end portions 16b of the prominent portion 16. In this regard, the central portion 16a of the prominent portion 16 may appear to be “pinched” inward relative to the opposing end portions 16b. The prominent portions 16 are not limited to having a peanut shape, and other shapes, such as spherical, cylindrical, oval, elliptical, cubical, or other three-dimensional polygonal shapes, are within the scope of the present disclosure. Further, the shape of one prominent portion 16 of the internal structure 14 may differ from one or more of the other prominent portions 16 of the internal structure. FIGS. 2D and 2E illustrate a second embodiment in which the prominent portions 16 are elliptically shaped. However, the peanut shape of the prominent portion 16 may be beneficial to help prohibit the prominent portion 16 from sliding out the side of the outer covering 12 during use of the stickbait fishing lure 10. A more rounded shape, such as shown in FIGS. 2D and 2E, creates an outward-facing curve, which may make it easier for the prominent portion 16 to protrude from the side of the outer covering 12. The inward-facing curvature of the peanut shape works against such protruding movement. The prominent portions 16 may, in the embodiment of FIGS. 2A to 2C, include one or more arms 21 extending from the central portion 16a of the prominent portion 16. For instance, FIGS. 2A to 2C show two arms 21 extending in opposite directions from the central portion 16a. Each arm 21 may include a protrusion 23 at a distal end of the arm 21. In one embodiment, the overall length “L” of the internal structure 14 may be 52 mm. In such an embodiment, each prominent portion 16 may have a length “l” of 10.5 mm and a width “w” of 4.5 mm. Further, the span “s” of two arms 21 on the prominent portion 16, measured from the end of a protrusion 23 of one arm 21 to the end of the protrusion 23 of the opposite arm 21, may be 18 mm. Of course these dimensions are exemplary, and smaller and larger dimensions are within the scope of the present disclosure. The arms 21 may form, or otherwise correspond with the holes 18 or marks in the outer covering 12, as shown in FIG. 3. Thus, the number of prominent portions 16 may match the number of holes 18 in one side of the outer covering 12. The arms 21 and their respective protrusions 23 are discussed in further detail below.

The fishing hook may be passed through the prominent portion 16 and out of the opposite side of the outer covering 12 so as to be exposed outside of the stickbait fishing lure 10. As discussed above, the prominent portion 16 helps secure the fishing hook within the stickbait fishing lure 10 by providing an internal reinforcement that inhibits the inserted hook from ripping away from the stickbait fishing lure 10 or otherwise tearing the outer covering 12 and damaging the stickbait fishing lure 10. The internal structure 14, and particularly the prominent portions 16 thereof, may be configured and designed to allow repeated insertion and withdrawal of a fishing hook, so that the stickbait fishing lure 10 can be used repeatedly over time.

The internal structure 14 may also include a disc-shaped element 22 between adjacent prominent portions 16. A disc-shaped element 22 may also be provided on one or both ends of the internal structure 14 as shown in FIG. 2A. The disc-shaped elements 22 act as walls or stops, which function to better hold the internal structure 14 in place within the outer covering 12.

FIG. 2B is a one-dimensional side view of the internal structure 14, and FIG. 2C is an end view of the internal structure 14 shown in FIG. 2B. FIG. 2F is an end view of the internal structure 14 shown in FIG. 2E.

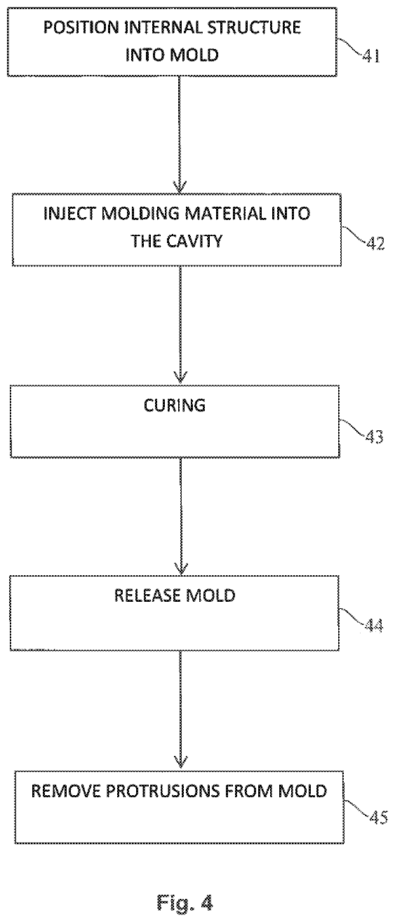

FIG. 4 illustrates a flow chart showing steps in a process of forming the stickbait fishing lure 10, according to an embodiment including the internal structure illustrated in FIGS. 2A to 2C. The process involves, at step 41, positioning the internal structure 14 into a cavity of a mold (not shown) so that each arm 21 of the prominent portions 16 engages a respective placeholder on the mold. Engagement of the arms 21 and the respective placeholder suspends the internal structure 14 within the cavity. In step 41, the internal structure 14 is positioned into the cavity of the mold so that the protrusions 23 of the arms 21 are located outside of the cavity, so as to be exposed externally of the mold. In step 42, a material, such as plastisol, is injected into the cavity to envelope the internal structure 14 (except for the protrusions 23 and, in some cases, a portion of the arms 21) and form an outer covering 12 having the internal structure 14 molded therein. In step 43, the material injected into the cavity is cured. After curing, in step 44 the mold is released from the outer covering 12 having the internal structure 14 therein. In step 45, the exposed protrusions 23 of the arms 21 are removed from the internal structure 14 (or from each prominent portion 16 of the internal structure 14), such as by cutting or tearing. In some cases, a portion of the arms 21 adjacent the protrusion 23 may also be removed. In an embodiment, removal of the protrusion 23(s) creates an aperture that forms the hole 18 or mark in the outer covering 12. The resultant aperture or mark that forms the hole 18 is located at a position on the outer covering 12 corresponding to the position of the prominent portion 16. In this process of forming the stickbait fishing lure 10, the internal structure may be formed of a material that is configured to be punctured with a fishing hook, such as silicon material.

The resultant stickbait fishing lure 10 formed by molding the internal structure 14 within the outer covering 12 may include some or all of the embodiments discussed herein. For instance, the internal structure 14 may further comprise the disc-shaped elements 22 discussed above.

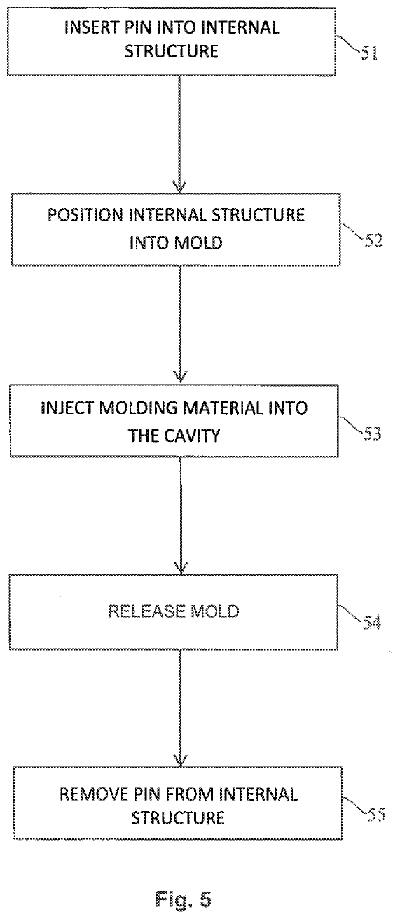

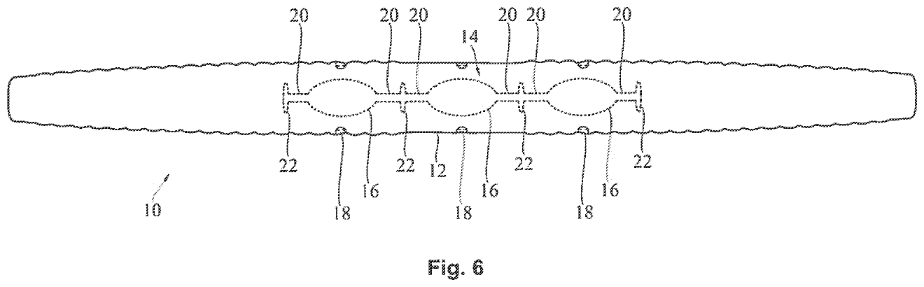

FIG. 5 illustrates a flow chart showing steps in a process of forming the stickbait fishing lure 10 including the internal structure of FIGS. 2D to 2F. The process involves, at step 51, inserting at least one pin (not shown) into an internal structure 14 so that the at least one pin protrudes from the internal structure 14. In an embodiment, a pin may be inserted into each prominent portion 16 of the internal structure 14 so that the pin in each prominent portion 16 protrudes from the prominent portion 16. In step 52, the internal structure 14 with the protruding pin(s) is positioned into a cavity of a mold (not shown) so that the pin(s) protruding from the internal structure 14 (or from each prominent portion 16) engages a respective placeholder on the mold. Engagement of the pin and the respective placeholder suspends the internal structure 14 within the cavity. In step 53, a material, such as plastisol, is injected into the cavity to envelope the internal structure 14 and form an outer covering 12 having the internal structure 14 molded therein. After curing, in step 54 the mold is released from the outer covering 12 having the internal structure 14 therein. In step 55, the pin(s) is removed from the internal structure 14 (or from each prominent portion 16 of the internal structure 14). In an embodiment, removal of the pin(s) creates an aperture that forms the hole 18 in the outer covering 12. In the case where each pin is withdrawn from one of the prominent portions 16, the resultant aperture that forms the hole 18 is located at a position on the outer covering 12 corresponding to the position of the prominent portion 16. In this process of forming the stickbait fishing lure 10, the internal structure may be formed of a material that is configured to be punctured with a fishing hook, such as silicon material. The resultant stickbait fishing lure 10 formed by molding the internal structure 14 within the outer covering 12 may include some or all of the embodiments discussed herein. FIG. 6 shows a view of the stickbait fishing lure 10 including the internal structure 14 of FIGS. 2D to 2F molded within the outer covering 12 formed according to the process in FIG. 5.

While various embodiments of the present invention have been described with emphasis, it should be understood that within the scope of the appended claims, the present invention might be practiced other than as specifically described herein.

What is claimed is:

1. A stickbait fishing lure comprising:
an outer covering; and
an internal structure molded within the outer covering, wherein the internal structure is of a material that is configured to be punctured by a fishing hook.

2. The stickbait fishing lure according to claim 1, wherein the material of the internal structure is silicon.

3. The stickbait fishing lure according to claim 1, wherein the outer covering is formed of plastisol material.

4. The stickbait fishing lure according to claim 1, wherein the internal structure includes a plurality of prominent portions along a length of the internal structure.

5. The stickbait fishing lure according to claim 4, wherein one or more of the plurality of prominent portions comprises a peanut shape.

6. The stickbait fishing lure according to claim 4, wherein at least one of the plurality of prominent portions comprises an arm extending therefrom.

7. The stickbait fishing lure according to claim 6, wherein the arm comprises a protrusion at a distal end thereof.

8. The stickbait fishing lure according to claim 4, wherein the internal structure further comprises a disc-shaped element adjacent one of the plurality of prominent portions.

9. A stickbait fishing lure comprising:
an outer covering; and
an internal structure molded within the outer covering, wherein
the internal structure includes a plurality of prominent portions along a length of the internal structure.

10. The stickbait fishing lure according to claim 9, wherein the internal structure is formed of silicon material.

11. The stickbait fishing lure according to claim 9, wherein the outer covering is formed of plastisol material.

12. The stickbait fishing lure according to claim 9, wherein one or more of the plurality of prominent portions comprises a peanut shape.

13. The stickbait fishing lure according to claim 9, wherein the internal structure further comprises a disc-shaped element adjacent one of the plurality of prominent portions.

14. The stickbait fishing lure according to claim 10, wherein at least one of the plurality of prominent portions comprises an arm extending therefrom, and the arm comprises a protrusion at a distal end thereof.

15. A process of forming a stickbait fishing lure, comprising:
positioning an internal structure into a cavity of a mold so that an arm of the internal structure engages a respective placeholder on the mold, and so that a protrusion of the arm is located outside of the cavity, so as to be exposed externally of the mold, wherein engagement of the arm and the respective placeholder suspends the internal structure within the cavity;
injecting a material into the cavity to envelope the internal structure and form an outer covering having the internal structure molded therein;
curing the material;
removing from the mold the outer covering having the internal structure molded therein; and
removing the protrusion from the internal structure.

16. The process according to claim 13, wherein the internal structure is formed of a material that is configured to be punctured with a fishing hook.

17. The process according to claim 13, wherein the internal structure is formed of silicon material.

18. The process according to claim 13, wherein the material injected into the cavity of the mold is plastisol.

17. The process according to claim 13, wherein the internal structure includes a plurality of prominent portions located along a length of the internal structure, and the arm extends from one of the plurality of prominent portions.

19. The process according to claim 17, wherein the internal structure further comprises a disc-shaped element between adjacent prominent portions.
